(19) United States
(12) Patent Application Publication
(10) Pub. No.: US 2026/0128697 A1
(43) Pub. Date: May 7, 2026

(54) MOTOR SPEED CONTROL METHOD, APPARATUS, DEVICE, AND STORAGE MEDIUM

(71) Applicant: AAC Acoustic Technologies (Shanghai) Co., Ltd., Shanghai (CN)

(72) Inventors: Xin Guo, Shanghai (CN); Yajun Zheng, Shanghai (CN)

(21) Appl. No.: 19/322,749

(22) Filed: Sep. 9, 2025

Related U.S. Application Data
(63) Continuation of application No. PCT/CN2024/130080, filed on Nov. 6, 2024.

(51) Int. Cl. H02P 23/14; G06F 3/01; H02P 23/00; H02P 25/06

(52) U.S. Cl. CPC H02P 23/14; G06F 3/016; H02P 23/0022; H02P 23/0077; H02P 25/06

(57) ABSTRACT

The present application provides a motor speed control method, apparatus, device, and storage medium. The method includes: acquiring a current speed of a target motor and a predetermined desired speed; calculating a target driving voltage value of the target motor according to a speed difference between the current speed and the desired speed; and generating a corresponding control instruction and transmitting the control instruction to a corresponding motor driving module. The control instruction instructs the motor driving module to output a corresponding driving voltage to control the speed of the target motor. The current speed of the target motor is monitored in real time and the speed error is calculated in real-time, realizing real-time closed-loop control of the target motor, ensuring that the target motor can always work in a better performance range, thereby effectively improving the haptic feedback effect and enhancing the user experience.

### CROSS-REFERENCE TO RELATED APPLICATIONS

This application is a continuation of International Application No. PCT/CN2024/130080, filed on Nov. 6, 2024, the entire contents of which are incorporated herein by reference.

### TECHNICAL FIELD

The present application relates to the field of motor control technologies, in particular to a motor speed control method, apparatus, device, and storage medium.

### BACKGROUND

The linear resonant actuator (LRA), also known as a linear motor, has been now widely used in a series of consumer electronic products, such as smartphones, tablets, VR, and smart wearable devices, which can provide haptic feedback, such as vibration alerts, touch feedback, etc. This haptic feedback can enhance the user's interactive experience with the device. Therefore, the linear motors are regarded as an important component in these consumer electronic products and play an important role in enhancing the user experience.

However, motors in practical applications may suffer from, for example, parameter uptake and nonlinear distortion due to low manufacturing precision and the motor's own physical characteristics, which can affect the experiential effect of the originally designed drive signals on haptic feedback. Therefore, it is necessary to control the motor in real-time so that the motor can always work within a good performance range and improve the user experience.

### SUMMARY

A main object of the present application is to provide a motor speed control method, apparatus, device, and storage medium, which can at least solve the problem of degradation of motor performance and influence of haptic feedback effect due to situations such as motor parameter regression and non-linear distortion in the related art.

In order to realize the above purpose, a first aspect of the present application provides a motor speed control method, including: acquiring a current speed of a target motor and a predetermined desired speed; calculating a target driving voltage value of the target motor according to a speed difference between the current speed and the desired speed; and generating a corresponding control instruction according to the target driving voltage value and transmitting the control instruction to a corresponding motor driving module, wherein the control instruction is configured to instruct the motor driving module to output a corresponding driving voltage to the target motor to control the speed of the target motor.

A second aspect of the present application provides a motor speed control apparatus, wherein the motor speed control apparatus includes: an acquisition module configured to acquire a current speed of a target motor and a predetermined desired speed; an error calculation module configured to calculate a target driving voltage value of the target motor according to a speed difference between the current speed and the desired speed; and an instruction generation module configured to generate a corresponding control instruction according to the target driving voltage value and transmit the control instruction to a corresponding motor driving module, wherein the control instruction is configured to instruct the motor driving module to output a corresponding driving voltage to the target motor to control the speed of the target motor.

A third aspect of the present application provides an electronic device including a memory and a processor configured to execute a computer program stored in the memory; wherein the processor, when executing the computer program, realizes the steps in the above-described motor speed control method provided in the first aspect of the present application.

A fourth aspect of the present application provides a computer-readable storage medium having a computer program stored thereon, wherein the computer program, when executed by a processor, realizes the steps in the above-described motor speed control method provided in the first aspect of the present application.

As can be seen from the above, according to the motor speed control method, apparatus, device, and readable storage medium provided in solutions of the present application, a current speed of a target motor and a predetermined desired speed are acquired; a target driving voltage value of the target motor is calculated according to a speed difference between the current speed and the desired speed; a corresponding control instruction is generated according to the target driving voltage value and transmitted to the corresponding motor driving module. The control instruction is configured to instruct the motor driving module to output a corresponding driving voltage to the target motor to control the speed of the target motor. Through the implementation of the scheme provided in the present application, the current speed of the target motor is monitored in real-time and the speed error is calculated in real-time, and the driving signal of the target motor is corrected so that the speed of the target motor can reach the desired speed, realizing real-time closed-loop control of the target motor, ensuring that the target motor can always work in a better performance range, thereby effectively improving the haptic feedback effect and enhancing the user experience.

### BRIEF DESCRIPTION OF THE DRAWINGS

In order to more clearly illustrate the technical solutions in the embodiments of the present application, the accompanying drawings to be used in the description of the embodiments will be briefly introduced below. Obviously, the accompanying drawings in the following description are only some embodiments of the present application, and for the person of ordinary skill in the field, other accompanying drawings may be obtained according to these drawings without putting in creative labor.

FIG. 1 shows a structural schematic diagram of an electronic device according to an embodiment of the present application.

FIG. 2 shows a basic flowchart of a motor speed control method according to an embodiment of the present application.

FIG. 3 shows a schematic diagram of the input and output of a discrete proportional integral differentiation (PID) controller according to an embodiment of the present application.

FIG. 4 shows a schematic diagram of a refined flow of a motor speed control method according to an embodiment of the present application.

FIG. 5 shows a refined flowchart of another motor speed control method according to an embodiment of the present application.

FIG. 6 shows a schematic diagram of modules of a motor speed control apparatus according to an embodiment of the present application.

FIG. 7 shows a structural schematic diagram of another electronic device according to an embodiment of the present application.

### DETAILED DESCRIPTION OF THE EMBODIMENTS

In order to make the inventive purpose, features, and advantages of the present application more obvious and understandable, the technical solutions in the embodiments of the present application will be described clearly and completely in the following in conjunction with the accompanying drawings in the embodiments of the present application. Obviously, the described embodiments are only a part of the embodiments of the present application rather than all of the embodiments. According to the embodiments in the present application, all other embodiments obtained by a person skilled in the art without creative labor fall within the scope of protection of the present application.

Furthermore, the terms “first” and “second” are used for descriptive purposes only, and are not to be construed as indicating or implying relative importance or implicitly specifying the number of technical features indicated. Thus, a feature defined with “first”, or “second” may expressly or implicitly include one or more such features. In the description of the embodiments of the present application, “more than one” means two or more than two, unless otherwise explicitly and specifically limited.

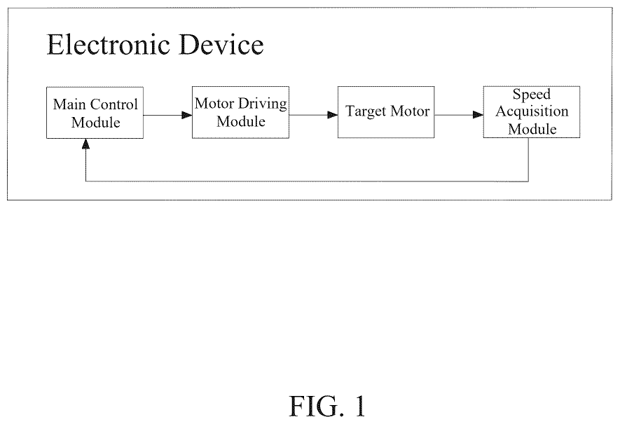

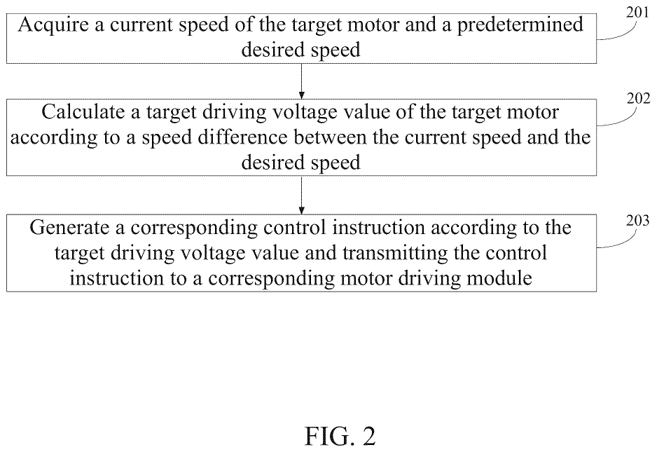

In order to solve the problem of degradation of motor performance and influence of tactile feedback effect due to ingress of motor parameters and non-linear distortion in related art, a first embodiment of the present application provides a motor speed control method applied to an electronic device. FIG. 1 shows a structural schematic diagram of an electronic device according to the embodiment of the embodiment, and the electronic device includes a target motor, a motor driving module, a speed acquisition module, and a main control module. FIG. 2 shows a basic flowchart of the motor speed control method according to the embodiment, and the motor speed control method includes the following steps.

Step 201, acquiring a current speed of the target motor and a predetermined desired speed.

Specifically, in this embodiment, a plurality of linear motors may be provided in the electronic device for providing tactile feedback for different positions of the electronic device, and the linear motor currently providing tactile feedback is taken as a target motor. When there are a plurality of target motors, real-time monitoring may be carried out for the speed of each target motor. The current speed of the target motor may be acquired in real-time by the speed acquisition module, and the current speed of the target motor is transmitted to the main control module, while the main control module also acquires the desired speed corresponding to the target motor. The desired speed corresponding to the target motor may be the same or different at different moments. The speed acquisition module in this embodiment may be a speed sensor, and the sensor with the corresponding acquisition precision may be selected according to the requirements of practical application. The main control module may be a device with certain computing and processing capabilities such as a Microcontroller Unit (MCU) or a Digital Signal Processor (DSP).

In some implementations of the embodiment, before the step of acquiring the current speed of the target motor and the desired speed, the method further includes: establishing a corresponding motor mathematical model according to characteristic parameters of the target motor; and inputting a predetermined desired voltage value into the motor mathematical model to obtain the desired speed.

Specifically, in the embodiment, modeling may be performed according to the physical characteristics of the target motor, so as to describe the behavior and performance of the target motor in the form of a mathematical expression and to understand and predict the motion characteristics of the target motor according to the motor mathematical module. The motor mathematical module may be in various forms, such as a transfer function, a state space model, etc., and the characteristic parameters of the motor may be electrical parameters (e.g., resistance, inductance, capacitance, etc., related to the driving current and voltage) and mechanical parameters (e.g., mass, inertia, damping, etc.). After the motor mathematical model is established, a suitable desired voltage signal is selected according to the practical application scenario, and the desired voltage signal is input into the motor mathematical model, so that the desired speed information of the target motor may be calculated by the module.

In some other implementations of the embodiment, before the step of acquiring the current speed of the target motor and the predetermined desired speed, the method further includes: acquiring, by a preset speed acquisition module, real-time speeds of the target motor for a plurality of times within a predetermined duration; and determining the current speed of the target motor according to the plurality of the real-time speeds.

Specifically, in this embodiment, in order to improve the accuracy of the determination of the speed of the target motor, the real-time speed of the target motor may also be acquired by the speed acquisition module (e.g., a speed sensor) multiple times within a predetermined time period, such as 3 s, to determine the current speed of the target motor according to the multiple real-time speeds acquired within the time period, and the multiple real-time speeds may be averaged and calculated or other statistical indicators may be used to determine the current speed of the target motor. The current speed of the target motor may be determined by averaging the multiple real-time speeds or in accordance with other statistical indicators, which can avoid the problem of lower reliability of the data due to the influence of system noise, sensor error, and other effects of a single measurement, thereby enhancing the credibility of the measurement results.

Step 202: calculating a target driving voltage value of the target motor according to a speed difference between the current speed and the desired speed.

Specifically, in this embodiment, after acquiring the current speed of the target motor, the main control module also calculates the speed difference between the current speed and the desired speed of the target motor, i.e., the error between the current speed and the desired speed, and calculates the target driving voltage value required to drive the target motor to reach the desired speed according to the speed difference.

In some implementations of the embodiment, the step of calculating the target driving voltage value of the target motor according to the speed difference between the current speed and the desired speed includes: acquiring a first historical speed difference value corresponding to a first historical moment and a second historical speed difference value corresponding to a second historical moment, where the first historical moment differs from the current moment by a unit length of time, and the second historical moment differs from the first historical moment by the unit length of time; performing a proportional integral differentiation calculation on a speed difference between the current speed and the desired speed, the first historical speed difference and the second historical speed difference to obtain an incremental voltage value; and summing the historical driving voltage value corresponding to the first historical moment and the incremental voltage value to obtain the target driving voltage value of the target motor.

Specifically, in this embodiment, the target driving voltage value of the target motor may be calculated according to a PID controller, i.e., a proportional integral differentiation controller. The PID controller is an automatic control algorithm that is based on performing proportional, integral, and differential operations on system feedback errors to produce control outputs for stable control of the system. In this embodiment, an incremental voltage value Δu(k) corresponding to the current moment is obtained by performing the proportional, integral, and differential operations on the speed difference corresponding to the current moment and the historical speed differences corresponding to the previous two historical moments, and the target driving voltage value u(k) corresponding to the current moment may be obtained by summing the incremental voltage value Δu(k) with the target driving voltage value calculated at the previous historical moment (i.e., the historical driving voltage value u(k−1)). The two historical moments are the first historical moment separated from the current moment by one unit of time, and the second historical moment separated from the current moment by two units of time, and the corresponding two historical speed difference values are calculated in the same way as the speed difference value corresponding to the current moment. Taking the first historical speed difference value as an example, the first historical speed difference value is a difference between the actual speed of the first historical moment and the motor desired speed corresponding to the first historical moment, and the motor desired speed corresponding to the first historical moment and the motor desired speed corresponding to the current moment may be the same or different.

Further, in some implementations of the embodiment, the step of performing the proportional integral differentiation calculation on the speed difference between the current speed and the desired speed, the first historical speed difference, and the second historical speed difference to obtain the incremental voltage value includes: performing a discrete proportional integral differentiation calculation on the speed difference between the current speed and the desired speed, the first historical speed difference and the second historical speed difference according to a discrete proportional integral differentiation formula to obtain the incremental voltage value, where the discrete proportional integral differentiation formula is Δu(k)=kₚ(e(k)−e(k−1))+kᵢe(k)+k_{d}(e(k)−2e(k−1)+e(k−2)), Δu(k) is the incremental voltage value, kₚ is a proportional coefficient, kᵢ is an integral coefficient, k_{d} is a differentiation coefficient, e(k) is the speed error; e(k−1) is the first historical speed difference, and e(k−2) is the second historical speed difference.

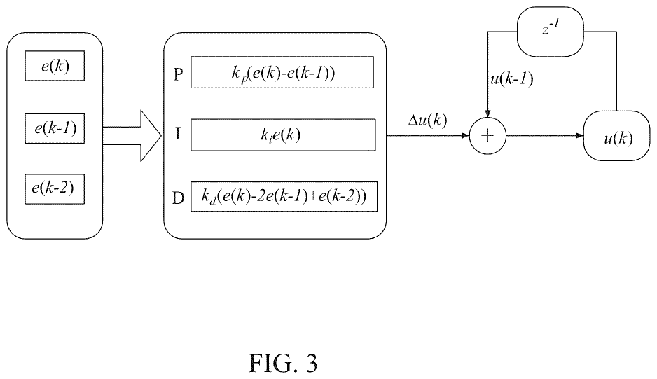

Specifically, for the PID controller, a common output expression is: u(t)=k_{P}*e(t)+kᵢ*∫e(t)dt+k_{d}*de(t)/dt, where kₚ is a proportional coefficient, kᵢ is an integral coefficient, k_{d} is a differentiation coefficient, and e(t) is a real-time error. The PID controllers can achieve error control by performing a proportional-integral-differential scaling operation on the error, allowing the actual output of the system to consistently track the desired output. In the actual control system, since the processor can only handle discrete signals, it is often necessary to discretize the continuous system. Similarly, for the PID controller, a discrete way is often adopted to control the system in the practical application. Therefore, in this embodiment, the target driving voltage value of the target motor is calculated according to the discrete PID controller. The inputs and outputs of this discrete PID controller are as shown in FIG. 3, where z⁻¹ is the discrete unit delay module. The proportional (P) action of the PID controller allows the PID controller to provide a fast and limited response to errors, the integral (I) action removes deviations of the system in the steady state and allows the system to more accurately track a setpoint value, and the differential (D) action predicts the future behavior of the system, suppresses changes in the error, and accelerates the response of the system.

In other implementations of the embodiment, before the step of calculating the target driving voltage value of the target motor according to the speed difference between the current speed and the desired speed, the method further includes: comparing the speed difference between the current speed and the desired speed with a predetermined error allowable range; and calculating the target driving voltage value of the target motor when the speed difference does not satisfy the error allowable range.

Specifically, before calculating the target driving voltage calculation, the size of the error between the current speed of the target motor and the desired speed may also be judged. If the current speed of the target motor is within the error allowable range, it may be determined that the current speed of the motor is able to ensure that the motor is in a better range of performance, and there is no need to correct the motor speed. Otherwise, it is necessary to calculate the target driving voltage value according to the speed difference between the current speed of the motor and the desired speed, in order to correct the motor speed and ensure the stability of the motor performance.

In other implementations of the embodiment, before the step of calculating the target driving voltage value of the target motor according to the speed difference between the current speed and the desired speed, the method further includes: acquiring a current output voltage value of the motor driving module; determining a matching relationship between the output voltage value and the current speed according to a predetermined motor driving speed index table; wherein the motor driving speed index table contains a mapping relationship between a driving voltage range and a motor speed range; and calculating the target driving voltage value of the target motor according to the speed difference between the current speed and the desired speed when the output voltage value does not match the current speed.

Specifically, in this embodiment, whether the motor speed meets the desired speed requirement may also be determined according to the current output voltage value of the motor driving module. The constructed motor mathematical model and the motor body may be utilized to conduct a simulation test of the relationship between the excitation and the speed, to construct a motor driving speed index table that is close to the actual working characteristics of the motor, and to record the correspondence between each driving voltage range and motor speed range in the index table. If the current speed of the motor does not match the current output voltage value of the motor driving module, it is determined that the performance of the motor is affected by, for example, parameter uptake and nonlinear distortion, and the motor speed needs to be controlled.

Step 203: generating a corresponding control instruction according to the target driving voltage value and transmitting the control instruction to a corresponding motor driving module.

Specifically, in this embodiment, after the main control module calculates the target driving voltage according to the PID controller, a corresponding control instruction for instructing the motor driving module to output a corresponding driving voltage to the target motor is generated, so as to control the speed of the target motor. The target driving voltage is the corrected driving voltage. The motor driving module generates the corresponding driving voltage after receiving the control instruction, and outputs it to the target motor after power amplification to control the speed of the target motor to reach the desired speed.

According to the technical solutions of the embodiment of the present application described above, a current speed of a target motor and a predetermined desired speed are acquired; a target driving voltage value of the target motor is calculated according to a speed difference between the current speed and the desired speed; a corresponding control instruction is generated according to the target driving voltage value and transmitted to the corresponding motor driving module. The control instruction is configured to instruct the motor driving module to output a corresponding driving voltage to the target motor to control the speed of the target motor. Through the implementation of the scheme provided in the present application, the current speed of the target motor is monitored in real time and the speed error is calculated in real time, and the driving signal of the target motor is corrected so that the speed of the target motor can reach the desired speed, realizing real-time closed-loop control of the target motor, ensuring that the target motor can always work in a better performance range, thereby effectively improving the haptic feedback effect and enhancing the user experience.

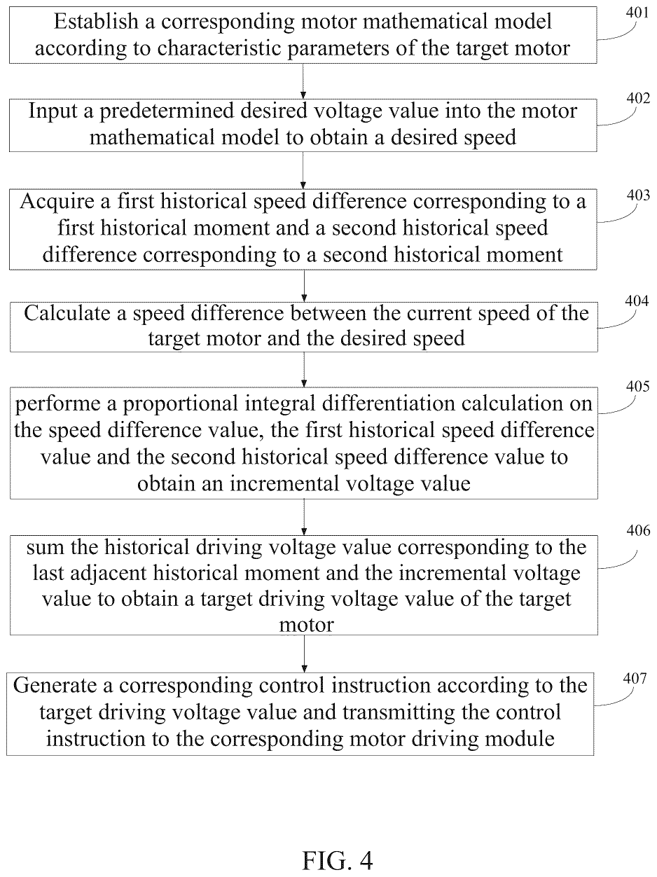

FIG. 4 shows a schematic diagram of a refined flow of a motor speed control method according to an embodiment of the present application, where the motor speed control method includes the following steps:
Step 401, establishing a corresponding motor mathematical model according to characteristic parameters of the target motor;
Step 402, inputting a predetermined desired voltage value into the motor mathematical model to obtain a desired speed;
Step 403, acquiring a first historical speed difference corresponding to a first historical moment and a second historical speed difference corresponding to a second historical moment;
Step 404, calculating a speed difference between the current speed of the target motor and the desired speed;
Step 405, performing a proportional integral differentiation calculation on the speed difference value, the first historical speed difference value and the second historical speed difference value to obtain an incremental voltage value;
Step 406: summing the historical driving voltage value corresponding to the last adjacent historical moment and the incremental voltage value to obtain a target driving voltage value of the target motor;
Step 407: generating a corresponding control instruction according to the target driving voltage value and transmitting the control instruction to the corresponding motor driving module.

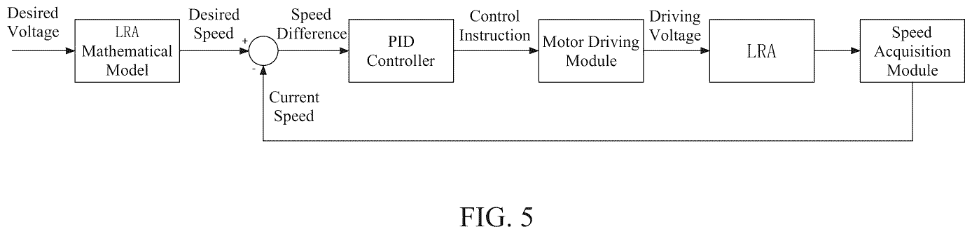

Specifically, as shown in the flowchart of the motor speed control method of FIG. 5, in order to realize the closed-loop tracking control of the motor speed, the target motor may first be modeled according to the physical characteristics of the target motor. After the establishment of the motor mathematical model is completed, a suitable desired voltage signal is selected according to the actual application scenario, and the desired voltage signal is input into the motor mathematical model, and the desired speed information of the target motor may be calculated by the model. Then, the current speed of the target motor is obtained by the speed acquisition module, and the speed difference between the current speed and the desired speed of the target motor is calculated. Next, the target driving voltage value of the target motor is calculated according to the PID controller. Specifically, the incremental voltage value Δu(k) corresponding to the current moment is obtained by performing proportional, integral, and differential operations on the speed difference corresponding to the current moment and the historical speed differences corresponding to the previous two historical moments, and the target driving voltage value u(k) corresponding to the current moment may be obtained by summing the incremental voltage value Δu(k) with the target driving voltage value calculated at the previous historical moment (i.e., the historical driving voltage value u(k−1)). The two historical moments are the first historical moment separated from the current moment by one unit of time and the second historical moment separated from the current moment by two units of time, and the corresponding two historical speed difference values are calculated in the same way as the corresponding speed difference value of the current moment. Finally, after calculating the target driving voltage according to the PID controller, the main control module will generate a corresponding control instruction for instructing the motor driving module to output the corresponding driving voltage to the target motor to control the target motor speed to reach the desired speed. This ensures that the target motor can always work in a better performance range, thereby effectively improving the haptic feedback effect and enhancing the user experience.

It should be understood that the size of the serial numbers of the steps in this embodiment does not imply the order of execution of the steps, and the order of execution of the steps should be determined by their functions and inherent logic, without constituting a unique limitation on the implementation process of the embodiments of the present application.

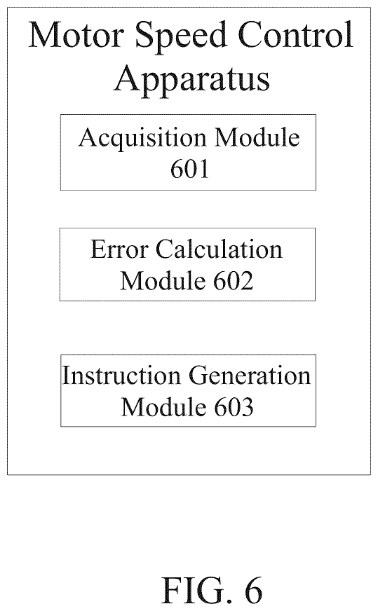

FIG. 6 shows a schematic diagram of modules of a motor speed control apparatus according to an embodiment of the present application, and the motor speed control apparatus may be applied to the aforementioned motor speed control method. As shown in FIG. 6, the motor speed control apparatus mainly includes:
An acquisition module 601 configured to acquire a current speed of a target motor and a predetermined desired speed;
An error calculation module 602 configured to calculate a target driving voltage value of the target motor according to a speed difference between the current speed and the desired speed; and
An instruction generation module 603 configured to generate a corresponding control instruction according to the target driving voltage value and transmit the control instruction to a corresponding motor driving module. The control instruction is configured to instruct the motor driving module to output a corresponding driving voltage to the target motor to control the speed of the target motor.

In some implementations of the embodiment, before performing the function of acquiring the current speed and the desired speed of the target motor, the acquisition module is further configured to establish a corresponding motor mathematical model according to characteristic parameters of the target motor; and input a predetermined desired voltage value into the motor mathematical model to obtain the desired speed.

In some other implementations of the embodiment, before acquiring the current speed of the target motor and the predetermined desired speed, the acquiring module is further configured to acquire, by a preset speed acquisition module, real-time speeds of the target motor for a plurality of times within a predetermined duration; and determine the current speed of the target motor according to the plurality of the real-time speeds.

In some implementations of the embodiment, the error calculation module is specifically configured to: acquire a first historical speed difference value corresponding to a first historical moment and a second historical speed difference value corresponding to a second historical moment; wherein the first historical moment differs from the current moment by a unit length of time, and the second historical moment differs from the first historical moment by the unit length of time; perform a proportional integral differentiation calculation on a speed difference between the current speed and the desired speed, the first historical speed difference and the second historical speed difference to obtain an incremental voltage value; and sum the historical driving voltage value corresponding to the first historical moment and the incremental voltage value to obtain the target driving voltage value of the target motor.

Further, in some implementations of the embodiment, in performing the function of performing the proportional integral differentiation calculation on the speed difference between the current speed and the desired speed, the first historical speed difference and the second historical speed difference to obtain the incremental voltage value, the error calculation module is specifically configured to perform a discrete proportional integral differentiation calculation on the speed difference between the current speed and the desired speed, the first historical speed difference and the second historical speed difference according to a discrete proportional integral differentiation formula to obtain the incremental voltage value. The discrete proportional integral differentiation formula is Δu(k)=kₚ(e(k)−e(k−1))+kᵢe(k)+k_{d}(e(k)−2e(k−1)+e(k−2)), Δu(k) is the incremental voltage value, kₚ is a proportional coefficient, kᵢ is an integral coefficient, k_{d} is a differentiation coefficient, e(k) is the speed error; e(k−1) is the first historical speed difference, and e(k−2) is the second historical speed difference.

In other implementations of the embodiment, before calculating the target driving voltage value of the target motor according to the speed difference between the current speed and the desired speed, the error calculation module is further configured to: compare the speed difference between the current speed and the desired speed with a predetermined error allowable range; and calculate the target driving voltage value of the target motor according to the speed difference between the current speed and the desired speed when the speed difference does not satisfy the error allowable range.

In other implementations of the embodiment, before calculating the target driving voltage value of the target motor according to the speed difference between the current speed and the desired speed, the error calculation module is further configured to: acquire a current output voltage value of the motor driving module; determine a matching relationship between the output voltage value and the current speed according to a predetermined motor driving speed index table, where the motor driving speed index table contains a mapping relationship between a driving voltage range and a motor speed range; and calculate the target driving voltage value of the target motor according to the speed difference between the current speed and the desired speed when the output voltage value does not match the current speed.

It should be noted that the motor speed control methods in the foregoing embodiments may all be realized according to the motor speed control apparatus provided in the embodiment. It is clearly understood by a person of ordinary skill in the art that, for the convenience and brevity of the description, the specific working process of the motor speed control apparatus described in this embodiment may be referred to the corresponding process in the foregoing embodiments of the method, and will not be repeated herein.

According to the technical solution of the above embodiment of the present application, a current speed of a target motor and a predetermined desired speed are acquired; a target driving voltage value of the target motor is calculated according to a speed difference between the current speed and the desired speed; a corresponding control instruction is generated according to the target driving voltage value and transmitted to the corresponding motor driving module. The control instruction is configured to instruct the motor driving module to output a corresponding driving voltage to the target motor to control the speed of the target motor. Through the implementation of the scheme provided in the present application, the current speed of the target motor is monitored in real time and the speed error is calculated in real-time, and the driving signal of the target motor is corrected so that the speed of the target motor can reach the desired speed, realizing real-time closed-loop control of the target motor, ensuring that the target motor can always work in a better performance range, thereby effectively improving the haptic feedback effect and enhancing the user experience.

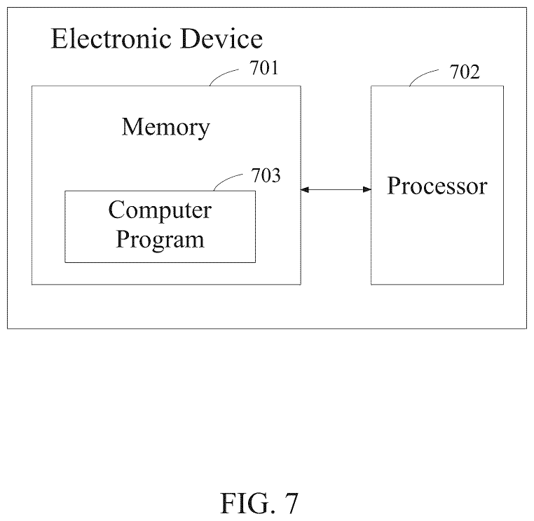

FIG. 7 shows a structural schematic diagram of another electronic device according to an embodiment of the present application, and the electronic device may be configured to realize the motor speed control method in the preceding embodiment and mainly includes:

A memory 701, a processor 702, and a computer program 703 stored on the memory 701 and runnable on the processor 702. The memory 701 is communicated with the processor 702. The processor 702 implements the method in the preceding embodiment one or two when it executes the computer program 703, and the number of processors may be one or more.

The memory 701 may be a high-speed random access memory (RAM), or a non-volatile memory, such as a disk memory. The memory 701 is configured to store executable program code, and the processor 702 is coupled to the memory 701.

Further, embodiments of the present application also provide a computer-readable storage medium, which may be provided in the above-described electronic device, and may be a memory in the embodiment shown in FIG. 7.

The computer-readable storage medium has a computer program stored thereon. The computer program, when executed by a processor, implements the motor speed control method of the aforementioned embodiments. Further, the computer-readable storage medium may also be a USB flash drive, a removable hard disk, a read-only memory (ROM), a RAM, a diskette, a CD-ROM, and various other media that can store the program code.

In the several embodiments provided in the present application, it should be understood that the apparatuses and methods disclosed, may be realized in other ways. For example, the above-described embodiments of the device are merely schematic, e.g., the division of modules, which is merely a logical functional division, may be divided in other ways when actually implemented. For another example, multiple modules or components may be combined or may be integrated into another system, or some features may be ignored, or not implemented. At another point, the mutual coupling, direct coupling or communication connection shown or discussed may be an indirect coupling or communication connection through some interface, device, or module, which may be electrical, mechanical, or otherwise.

The modules illustrated as separate components may or may not be physically separate, and the components shown as modules may or may not be physical modules, i.e., they may be located in a single place or they may be distributed to a plurality of network modules. Some or all of these modules may be selected to fulfill the purpose of the embodiment scheme according to actual needs.

In addition, the various functional modules in the various embodiments of the present application may be integrated in a single processing module, or the individual modules may be physically present separately, or two or more modules may be integrated in a single module. The above integrated modules may be implemented either in the form of hardware or in the form of software function modules.

The integrated modules, when implemented in the form of software function modules and sold or used as separate products, may be stored in a computer-readable storage medium. According to this understanding, the technical solution of the present application may be embodied, in essence, or as a contribution to the prior art, or in whole or in part, in the form of a software product, which is stored in a computer-readable storage medium and includes a number of instructions to enable a computer device (which may be a personal computer, a server, or a network device, etc.) to perform all or part of the steps of the method of the various embodiments of the present application, or to perform all or part of the steps of the method of the various embodiments of the present application. The aforementioned readable storage medium includes a USB flash drive, a removable hard disk, a ROM, a RAM, a diskette, a CD-ROM, and other media that can store program code.

It should be noted that the aforementioned method embodiments are expressed as a series of action combinations for the sake of simplicity of description, but the person skilled in the art should be aware that the present application is not limited by the order of the described actions. According to the present application, some of the steps may be carried out in a different order or at the same time. Secondly, the person skilled in the art should also be aware that the embodiments described in the specification are preferred embodiments, and the actions and modules involved are not necessarily necessary for the present application.

In the above embodiments, the description of each embodiment has its own focus, and the part that is not described in detail in a certain embodiment may be referred to as the relevant description of other embodiments.

Described above is a description of the motor speed control method, apparatus, device, and storage medium provided in the present application. For the person skilled in the art, according to the ideas of the embodiments of the present application, there will be changes in the specific implementation and application scope. In summary, the contents of this specification should not be construed as a limitation of the present application.

What is claimed is:

1. A motor speed control method, comprising:
acquiring a current speed of a target motor and a predetermined desired speed;
calculating a target driving voltage value of the target motor according to a speed difference between the current speed and the desired speed; and
generating a corresponding control instruction according to the target driving voltage value and transmitting the control instruction to a corresponding motor driving module, wherein the control instruction is configured to instruct the motor driving module to output a corresponding driving voltage to the target motor to control the speed of the target motor.

2. The motor speed control method of claim 1, wherein before the step of acquiring the current speed of the target motor and the predetermined desired speed, the method further comprises:
establishing a corresponding motor mathematical model according to characteristic parameters of the target motor; and
inputting a predetermined desired voltage value into the motor mathematical model to obtain the desired speed.

3. The motor speed control method of claim 1, wherein before the step of acquiring the current speed of the target motor and the predetermined desired speed, the method further comprises:
acquiring, by a preset speed acquisition module, real-time speeds of the target motor for a plurality of times within a predetermined duration; and
determining the current speed of the target motor according to the plurality of the real-time speeds.

4. The motor speed control method of claim 1, wherein the step of calculating the target driving voltage value of the target motor according to the speed difference between the current speed and the desired speed comprises:
acquiring a first historical speed difference value corresponding to a first historical moment and a second historical speed difference value corresponding to a second historical moment; wherein the first historical moment differs from the current moment by a unit length of time, and the second historical moment differs from the first historical moment by the unit length of time;
performing a proportional integral differentiation calculation on a speed difference between the current speed and the desired speed, the first historical speed difference and the second historical speed difference to obtain an incremental voltage value; and
summing the historical driving voltage value corresponding to the first historical moment and the incremental voltage value to obtain the target driving voltage value of the target motor.

5. The motor speed control method of claim 4, wherein the step of performing the proportional integral differentiation calculation on the speed difference between the current speed and the desired speed, the first historical speed difference and the second historical speed difference to obtain the incremental voltage value comprises:
performing a discrete proportional integral differentiation calculation on the speed difference between the current speed and the desired speed, the first historical speed difference and the second historical speed difference according to a discrete proportional integral differentiation formula to obtain the incremental voltage value;
wherein the discrete proportional integral differentiation formula is Δu(k)=kₚ(e(k)−e(k−1))+kᵢe(k)+k_{d}(e(k)−2e(k−1)+e(k−2)), Δu(k) is the incremental voltage value, kₚ is a proportional coefficient, kᵢ is an integral coefficient, k_{d} is a differentiation coefficient, e(k) is the speed error; e(k−1) is the first historical speed difference, and e(k−2) is the second historical speed difference.

6. The motor speed control method of claim 1, wherein before the step of calculating the target driving voltage value of the target motor according to the speed difference between the current speed and the desired speed, the method further comprises:
comparing the speed difference between the current speed and the desired speed with a predetermined error allowable range; and
calculating the target driving voltage value of the target motor according to the speed difference between the current speed and the desired speed when the speed difference does not satisfy the error allowable range.

7. The motor speed control method of claim 1, wherein before the step of calculating the target driving voltage value of the target motor according to the speed difference between the current speed and the desired speed, the method further comprises:
acquiring a current output voltage value of the motor driving module;
determining a matching relationship between the output voltage value and the current speed according to a predetermined motor driving speed index table; wherein the motor driving speed index table contains a mapping relationship between a driving voltage range and a motor speed range; and
calculating the target driving voltage value of the target motor according to the speed difference between the current speed and the desired speed when the output voltage value does not match the current speed.

8. An electronic device, comprising:
a memory; and
a processor configured to execute a computer program stored on the memory;
wherein the processor, when executing the computer program, realizes the steps of:
acquiring a current speed of a target motor and a predetermined desired speed;
calculating a target driving voltage value of the target motor according to a speed difference between the current speed and the desired speed; and
generating a corresponding control instruction according to the target driving voltage value and transmitting the control instruction to a corresponding motor driving module, wherein the control instruction is configured to instruct the motor driving module to output a corresponding driving voltage to the target motor to control the speed of the target motor.

9. The electronic device of claim 8, wherein before the step of acquiring the current speed of the target motor and the predetermined desired speed, the processor further realizes the steps of:
establishing a corresponding motor mathematical model according to characteristic parameters of the target motor; and
inputting a predetermined desired voltage value into the motor mathematical model to obtain the desired speed.

10. The electronic device of claim 8, wherein before the step of acquiring the current speed of the target motor and the predetermined desired speed, the processor further realizes the steps of:
acquiring, by a preset speed acquisition module, real-time speeds of the target motor for a plurality of times within a predetermined duration; and
determining the current speed of the target motor according to the plurality of the real-time speeds.

11. The electronic device of claim 8, wherein the step of calculating the target driving voltage value of the target motor according to the speed difference between the current speed and the desired speed comprises:
acquiring a first historical speed difference value corresponding to a first historical moment and a second historical speed difference value corresponding to a second historical moment; wherein the first historical moment differs from the current moment by a unit length of time, and the second historical moment differs from the first historical moment by the unit length of time;
performing a proportional integral differentiation calculation on a speed difference between the current speed and the desired speed, the first historical speed difference and the second historical speed difference to obtain an incremental voltage value; and
summing the historical driving voltage value corresponding to the first historical moment and the incremental voltage value to obtain the target driving voltage value of the target motor.

12. The electronic device of claim 11, wherein the step of performing the proportional integral differentiation calculation on the speed difference between the current speed and the desired speed, the first historical speed difference and the second historical speed difference to obtain the incremental voltage value comprises:
performing a discrete proportional integral differentiation calculation on the speed difference between the current speed and the desired speed, the first historical speed difference and the second historical speed difference according to a discrete proportional integral differentiation formula to obtain the incremental voltage value;
wherein the discrete proportional integral differentiation formula is Δu(k)=kₚ(e(k)−e(k−1))+kᵢe(k)+k_{d}(e(k)−2e(k−1)+e(k−2)), Δu(k) is the incremental voltage value, kₚ is a proportional coefficient, kᵢ is an integral coefficient, k_{d} is a differentiation coefficient, e(k) is the speed error; e(k−1) is the first historical speed difference, and e(k−2) is the second historical speed difference.

13. The electronic device of claim 8, wherein before the step of calculating the target driving voltage value of the target motor according to the speed difference between the current speed and the desired speed, the processor further realizes the steps of:
comparing the speed difference between the current speed and the desired speed with a predetermined error allowable range; and
calculating the target driving voltage value of the target motor according to the speed difference between the current speed and the desired speed when the speed difference does not satisfy the error allowable range.

14. The electronic device of claim 8, wherein the step of calculating the target driving voltage value of the target motor according to the speed difference between the current speed and the desired speed further comprises:
acquiring a current output voltage value of the motor driving module;
determining a matching relationship between the output voltage value and the current speed according to a predetermined motor driving speed index table; wherein the motor driving speed index table contains a mapping relationship between a driving voltage range and a motor speed range; and
calculating the target driving voltage value of the target motor according to the speed difference between the current speed and the desired speed when the output voltage value does not match the current speed.

15. A computer-readable storage medium having a computer program stored thereon, wherein the computer program, when executed by a processor, realizes the steps in the motor speed control method of claim 1.
